(19) United States
(12) Patent Application Publication
(10) Pub. No.: US 2008/0145545 A1
(43) Pub. Date: Jun. 19, 2008

(54) METAL OXIDE AND SULFUR-CONTAINING COATING COMPOSITIONS, METHODS OF USE, AND ARTICLES PREPARED THEREFROM

(76) Inventors: Bret Ja Chisholm, West Fargo, ND (US); James Edward Pickett, Schenectady, NY (US)

Correspondence Address: CANTOR COLBURN, LLP, 20 Church Street, 22nd Floor, Hartford, CT, 06103, US

(21) Appl. No.: 11/611,397

(22) Filed: Dec. 15, 2006

(51) Int. Cl. C08F 2/44; B05D 3/02; C08F 2/46; C08J 3/28; C08K 3/34; C08K 5/54; C08K 5/56

(52) U.S. Cl. 427/385.5; 522/1; 524/730; 524/780; 524/789; 524/853

(57) ABSTRACT

Disclosed herein are high refractive index coating compositions containing a functionalized metal oxide nanoparticle and sulfur-containing polymerizable components. The composition can be prepared into optical articles via curing processes.

### BACKGROUND OF INVENTION

In backlit computer displays or other display systems, optical films are commonly used to direct light. For example, in backlit displays, light management films use prismatic structures (often referred to as microstructure) to direct light along a viewing axis (i.e., an axis substantially normal to the display). Directing the light enhances the brightness of the display viewed by a user and allows the system to consume less power in creating a desired level of on-axis illumination. Films for turning or directing light can also be used in a wide range of other optical designs, such as for projection displays, traffic signals, and illuminated signs.

Compositions used to form light management films to direct light desirably have the ability to replicate the microstructure needed to provide the light directing capability upon cure. It is furthermore desirable for the glass transition temperature (Tg) of the cured composition to be high enough for shape retention during storage and use. It is also desirable for light management films made from the cured composition to exhibit high brightness. Finally, the composition used to make light management films advantageously provides a cured composition having a high refractive index.

While a variety of materials are presently available for use in light management films, there remains a continuing need for still further improvement in the materials used to make them, particularly materials that upon curing possess the combined attributes desired to satisfy the increasingly exacting requirements for light management film applications.

### BRIEF DESCRIPTION OF THE INVENTION

In one embodiment, a polymerizable composition comprises functionalized metal oxide nanoparticles; and a high refractive index sulfur-containing monomer according to the general structures (I) or (II)

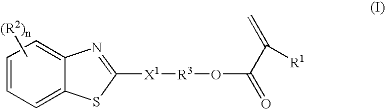

wherein R¹ is hydrogen or methyl; R² is independently at each occurrence a C₁-C₂₀ alkyl, C₃-C₃₀ cycloalkyl, C₄-C₂₀ aryl, C₄-C₂₀ heteroaryl, (C₁-C₂₀alkyl)S—, C₁-C₂₀alkoxy, (C₁-C₂₀alkyl)₂N—, (C₁-C₂₀alkyl)(H)N—, halogen, nitro, or cyano group; n is an integer from 0-4; X¹ is a bond, a sulfur atom, selenium atom, SO group (sulfoxide), SO₂ (sulfonyl group), oxygen atom, amino group, carbonyl group, or carbonyloxy group; and R³ is C₁-C₂₀ alkylene, C₃-C₃₀ cycloalkylene, or C₆-C₃₀ arylene; or

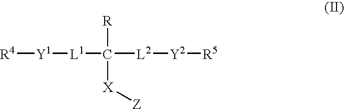

wherein Z is an ethylenically unsaturated group; X is O, S, or NH; L¹ and L² are each independently C₁-C₃ alkylene, —(C₁-C₃ alkylene)-S—(C₁-C₃ alkylene)-, or —(C₁-C₃ alkylene)-O—(C₁-C₃ alkylene)-; R is hydrogen or C₁-C₆ alkyl; R⁴ and R⁵ are each independently aryl, including phenyl or naphthyl, aryl(C₁-C₆ alkylene)-, heteroaryl, or heteroaryl(C₁-C₆ alkylene)-, each of which group is substituted with 0 to 5 substituents independently chosen from halogen, C₁-C₄alkyl, C₁-C₄alkoxy, (C₁-C₄alkyl)S—, C₁-C₄haloalkyl, and C₁-C₄haloalkoxy; and Y¹ and Y² are each independently O, S, NH, or N, with the proviso that at least one of X, Y¹ or Y² is S.

In still another embodiment, a method of making a cured film comprises blending functionalized metal oxide nanoparticles, a high refractive index sulfur-containing monomer, and optionally a polymerization initiator to form a polymerizable composition; casting the polymerizable composition to form a film; exposing the film to radiation energy or heat sufficient to polymerize the composition to form a cured film; wherein the high refractive index sulfur-containing monomer has the general structure (I) or (II)

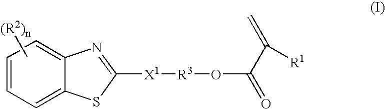

wherein R¹ is hydrogen or methyl; R² is independently at each occurrence a C₁-C₂₀ alkyl, C₃-C₃₀ cycloalkyl, C₄-C₂₀ aryl, C₄-C₂₀ heteroaryl, (C₁-C₂₀alkyl)S—, C₁-C₂₀alkoxy, (C₁-C₂₀alkyl)₂N—, (C₁-C₂₀alkyl)(H)N—, halogen, nitro, or cyano group; n is an integer from 0-4; X¹ is a bond, a sulfur atom, selenium atom, SO group (sulfoxide), SO₂ (sulfonyl group), oxygen atom, amino group, carbonyl group, or carbonyloxy group; and R³ is C₁-C₂₀ alkylene, C₃-C₃₀ cycloalkylene, or C₆-C₃₀ arylene; or

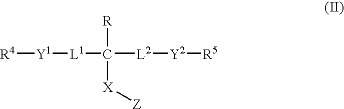

wherein Z is an ethylenically unsaturated group; X is O, S, or NH; L¹ and L² are each independently C₁-C₃ alkylene, —(C₁-C₃ alkylene)-S—(C₁-C₃ alkylene)-, or —(C₁-C₃ alkylene)-O—(C₁-C₃ alkylene)-; R is hydrogen or C₁-C₆ alkyl; R⁴ and R⁵ are each independently aryl, including phenyl or naphthyl, aryl(C₁-C₆ alkylene)-, heteroaryl, or heteroaryl(C₁-C₆ alkylene)-, each of which group is substituted with 0 to 5 substituents independently chosen from halogen, C₁-C₄alkyl, C₁-C₄alkoxy, (C₁-C₄alkyl)S—, C₁-C₄haloalkyl, and C₁-C₄haloalcoxy; and Y¹ and Y² are each independently O, S, NH, or N, with the proviso that at least one of X, Y¹ or Y² is S.

### BRIEF DESCRIPTION OF DRAWINGS

FIG. 1 is a perspective view of an exemplary backlit display device including a light management film and a multiwall sheet.

FIG. 2 is a perspective view of an exemplary light management film with prismatic surfaces.

### DETAILED DESCRIPTION

Disclosed herein are polymerizable compositions comprising functionalized metal oxide nanoparticles and a high refractive index sulfur-containing monomer. It has been found that the particular combination of the high refractive index metal oxide nanoparticles and high refractive index sulfur-containing monomers provides, upon polymerization, a cured film exhibiting a high refractive index. The polymerizable compositions are ideally suited for the production of optical articles due to their high refractive indices and ease of processing into films. Exemplary optical articles include light management films for use in backlit displays; projection displays; traffic signals; illuminated signs; optical lenses; Fresnel lenses; optical disks; diffuser films; holographic substrates; or as substrates in combination with conventional lenses, prisms or mirrors, and the like.

Also disclosed herein are methods of preparing the polymerizable compositions, and methods of forming films and articles with the polymerizable compositions.

As used herein, “(meth)acrylate” is inclusive of both acrylate and methacrylate functionality.

The terms “a” and “an” herein do not denote a imitation of quantity, but rather denote the presence of at least one of the referenced item. The term “or” means “and/or”. All ranges disclosed herein are inclusive and combinable.

As used herein “high refractive index” means a refractive index of greater than about 1.50.

The functionalized metal oxide nanoparticles that can be used to prepare the polymerizable composition include silicon, titanium, zirconium, cerium, or tin oxide nanoparticles prepared by methods known in the art. For example, metal oxide nanoparticles can be prepared by sol-gel processes. Typically, a sol-gel process employs hydrolysis of metal alkoxides, for example Ti(alkoxide)₄, in aqueous solutions. Once the metal oxide sol is formed, the nanoparticles within the sol can be treated with a functionalizing agent, such as an organosilane, to produce a functionalized metal oxide nanoparticle sol.

The metal oxide nanoparticles can be functionalized with an organosilane. In one embodiment, the organosilane is free of reactive groups such as epoxy, acrylate, methacrylate, vinyl, or other ethylenically unsaturated groups that may react with the polymerizable compounds described herein. Suitable organosilanes include alkoxyorganosilane, aryloxyorganosilane, arylalkoxyorganosilane, arlyalkylalkoxyorganosilane, alkylaminoorganosilane, combinations thereof, and the like. Suitable organosilanes include, for example, methyl trimethoxysilane, methyl triethoxysilane, propyl trimethoxysilane, propyl triethoxysilane, phenyl trimethoxysilane, phenyl triethoxysilane, phenethyl trimethoxysilane, phenyl trichlorosilane, diphenyldimethoxysilane, hexamethyldisilazane, trimethoxy(3-methoxypropyl)silane, 3-(trimethoxysilyl)propyl acetate, perfluoroalkyl trimethoxysilane, perfluoroalkyl triethoxysilane, perfluoromethyl alkyl trimethoxysilanes such as tridecafluoro-1,1,2,2-tetrahydrooctyl trimethoxysilane, perfluoroalkyl trichlorosilanes, trifluoromethylpropyl trimethoxysilane, trifluoromethylpropyl trichlorosilane, and the like.

The organosilane can be chosen to provide the maximum increase in refractive index to polymerizable compositions comprising the functionalized metal oxide nanoparticles. Organosilanes having high refractive indices include the aryl-containing organosilanes, as compared to the alkyl-containing organosilanes, and bromine substituted organosilanes.

In another embodiment, the organosilane contains one or more reactive groups. Exemplary reactive-group containing organosilanes include (meth)acryloxyalkyl trimethoxysilanes such as methacryloxypropyl trimethoxysilane, acryloxypropyl trimethoxysilane, methacryloxypropyl trichlorosilane, acryloxypropyl trichlorosilane, methacryloxypropyl triethoxysilane, and acryloxypropyl triethoxysilane; glycidoxypropyl trimethoxysilane, and glycidoxypropyl triethoxysilane; vinyl trimethoxysilane and vinyl triethoxysilane, and the like.

Particular functionalized metal oxide nanoparticles and the sol process used to prepare them can be found in U.S. patent application Publication 2005-0063898 to Chisholm, which is incorporated herein in its entirety. Other metal oxide nanoparticles and methods for their preparation are also described, for example, in U.S. Pat. No. 6,261,700 to Olson et al. and U.S. Pat. No. 6,291,070 to Arpac et al.

Typically, the functionalized metal oxide nanoparticles can have a size of about 1 nanometer to about 200 nanometers, specifically about 2 nanometers to about 40 nanometers, and more specifically about 3 nanometers to about 20 nanometers.

The functionalized metal oxide nanoparticles can be present in the polymerizable composition in an amount of about 1 to about 80 weight percent, specifically about 10 to about 70 weight percent, more specifically about 20 to about 60 weight percent, and yet more specifically about 30 to about 50 weight percent based on the total weight of the polymerizable composition. As used herein, the weight of the functionalized metal oxide nanoparticles or polymerizable composition excludes any solvent weight present if the nanoparticles are in the form of a sol or dispersion.

The high refractive index sulfur-containing monomer present in the polymerizable composition can be any number of radiation-reactive monomers containing at least one sulfur atom.

In one embodiment, the high refractive index sulfur-containing monomer is a sulfur-containing heterocyclic (meth)acrylate. The sulfur-containing heterocyclic (meth)acrylates can comprise specific classes of heterocycles, for example, a cyclic sulfide, a thioxanthene, a benzothiofuran, a thiopyran, a thiophene, a thiazole, a naphthothiazole, and the like.

In one embodiment, the sulfur-containing heterocyclic (meth)acrylate is a benzothiazole having the general structure (I)

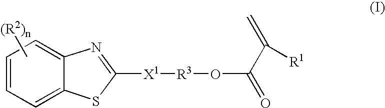

wherein R¹ is hydrogen or methyl; R² is independently at each occurrence a C₁-C₂₀ alkyl, C₃-C₃₀ cycloalkyl, C₄-C₂₀ aryl, C₄-C₂₀ heteroaryl, (C₁-C₂₀alkyl)S—, C₁-C₂₀alkoxy, (C₁-C₂₀alkyl)₂N—, (C₁-C₂₀alkyl)(H)N—, halogen, nitro, or cyano group; n is an integer from 0-4; X¹ is a bond, a sulfur atom, selenium atom, SO group (sulfoxide), SO₂ (sulfonyl group), oxygen atom, amino group, carbonyl group, or carbonyloxy group; and R³ is C₁-C₂₀ alkylene, C₃-C₃₀ cycloalkylene, or C₆-C₃₀ arylene. As used, the cycloalkyl groups can contain heteroatoms such as nitrogen, sulfur, or oxygen or may exclusively be composed of hydrogen and carbon.

In one embodiment, R² is (C₁-C₂₀alkyl)S—. Exemplary sulfur-containing heterocyclic (meth)acrylates include 2-(2-benzothiazolylthio)ethyl acrylate and 2-(2-benzothiazolylthio)ethyl(meth)acrylate.

As used herein, a dash (“-”) that is not between two letters or symbols is used to indicate a point of attachment for a substituent. For example, (C₁-C₄alkyl)S— is attached through the sulfur atom.

As used herein, “alkyl” includes both branched and straight chain saturated aliphatic hydrocarbon groups, having the specified number of carbon atoms. Examples of alkyl include, but are not limited to, methyl, ethyl, n-propyl, isopropyl, n-butyl, 3-methylbutyl, t-butyl, n-pentyl, and sec-pentyl.

As used herein “alkoxy” indicates an alkyl group as defined above with the indicated number of carbon atoms attached through an oxygen bridge (—O—). Examples of alkoxy include, but are not limited to, methoxy, ethoxy, n-propoxy, i-propoxy, n-butoxy, 2-butoxy, t-butoxy, n-pentoxy, 2-pentoxy, 3-pentoxy, isopentoxy, neopentoxy, n-hexoxy, 2-hexoxy, 3-hexoxy, and 3-methylpentoxy.

As used herein “haloalkyl” indicates both branched and straight-chain alkyl groups having the specified number of carbon atoms, substituted with 1 or more halogen atoms, generally up to the maximum allowable number of halogen atoms. Examples of haloalkyl include, but are not limited to, tribromomethyl, dibromomethyl, 2-bromoethyl, and pentabromoethyl.

“Haloalkoxy” indicates a haloalkyl group as defined above attached through an oxygen bridge.

“Halo” or “halogen” as used herein refers to fluoro, chloro, bromo, or iodo.

As used herein, “heteroaryl” indicates a stable aromatic ring which contains from 1 to 3, or specifically from 1 to 2, heteroatoms chosen from N, O, and S, with remaining ring atoms being carbon, or a stable bicyclic or tricyclic system containing at least one 5 to 7 membered aromatic ring which contains from 1 to 3, or specifically from 1 to 2, heteroatoms chosen from N, O, and S, with remaining ring atoms being carbon. When the total number of S and O atoms in the heteroaryl group exceeds 1, these heteroatoms are not adjacent to one another. Examples of heteroaryl groups include, but are not limited to, benzo[d]thiazolyl, benzo[d]oxazolyl, benzofuranyl, benzothiophenyl, benzoxadiazolyl, dihydrobenzodioxynyl, furanyl, imidazolyl, indolyl, isoxazolyl, oxazolyl, N-phenothiazinyl, pyranyl, pyrazinyl, pyrazolopyrimidinyl, pyrazolyl, pyridizinyl, pyridyl, pyrimidinyl, pyrrolyl, quinolinyl, tetrazolyl, thiazolyl, thienylpyrazolyl, thiophenyl, and triazolyl.

Other suitable high refractive index sulfur-containing monomers include those having the general structure (II)

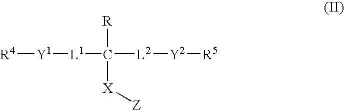

wherein Z is an ethylenically unsaturated group; X is O, S, or NH; L¹ and L² are each independently C₁-C₃ alkylene, —(C₁-C₃ alkylene)-S—(C₁-C₃ alkylene)-, or —(C₁-C₃ alkylene)-O—(C₁-C₃ alkylene)-; R is hydrogen or C₁-C₆ alkyl; R⁴ and R⁵ are each independently aryl, including phenyl or naphthyl, aryl(C₁-C₆ alkylene)-, heteroaryl, or heteroaryl(C₁-C₆ alkylene)-, each of which group is substituted with 0 to 5 substituents independently chosen from halogen, C₁-C₄alkyl, C₁-C₄alkoxy, (C₁-C₄alkyl)S—, C₁-C₄haloalkyl, and C₁-C₄haloalcoxy; and Y¹ and Y² are each independently O, S, NH, or N, with the proviso that at least one of X, Y¹ or Y² is S.

Z is an ethylenically unsaturated group, for example, acryloyl, methacryloyl, vinyl, alkyl, and the like; more specifically acryloyl and methacryloyl.

The L¹ and L² groups are each independently C₁-C₃ alkylene, more specifically C₁-C₂ alkylene, and yet more specifically C₁ alkylene. Moreover, the L¹ and L² groups are each independently —(C₁-C₃ alkylene)-S—(C₁-C₃ alkylene)-, or —(C₁-C₃ alkylene)-O—(C₁-C₃ alkylene)-; more specifically, —(C₁ alkylene)-S—(C₂ alkylene)-, —(C₂ alkylene)-S—(C₁ alkylene)-, —(C₁ alkylene)-O—(C₂ alkylene)-, or —(C₂ alkylene)-O—(C₁ alkylene)-; and the like.

The R group can be hydrogen or C₁-C₆ alkyl, more specifically hydrogen or C₁-C₃ alkyl, and yet more specifically hydrogen.

Suitable aryl groups for R⁴ and R⁵ include, for example, phenyl and naphthyl groups, each of which group is substituted with 0 to 5 substituents independently chosen from halogen, C₁-C₄alkyl, C₁-C₄alkoxy, (C₁-C₄alkyl)S—, C₁-C₄haloalkyl, and C₁-C₄haloalkoxy. Exemplary R⁴ and R⁵ groups include phenyl, 3-bromophenyl, 4-bromophenyl, 2,4,6-tribromophenyl, naphthyl, the heteroaryl groups described herein, specifically benzo[d]thiazolyl, benzo[d]oxazolyl, N-phenothiazinyl, and the like.

When Y¹ or Y² is N, then each corresponding combination R⁴—Y¹ or R⁵—Y² is independently an N-containing heteroaryl, wherein the nitrogen of the heteroaryl is covalently bonded to the L¹ or L² group respectively. Suitable N-containing heteroaryls include, for example, N-10H-phenothiazinyl, N-1H-indolyl, benzimidazolyl, imidazolyl, N-9,10-dihydroacridinyl, and the like.

Specific examples of high refractive index sulfur-containing monomers according to general structure (II) include 1,3-bis(4-methylphenylthio)-2-propyl acrylate; 1,3-bis(2-mercaptobenzothiazoyl)-2-propyl acrylate or 1,3-bis(benzo[d]thiazol-2-ylthio)propan-2-yl acrylate; 1,3-bis(phenylthio)propan-2-yl acrylate; 1,3-bis(4-bromophenylthio)propan-2-yl acrylate; 1,3-bis(3-bromophenylthio)propan-2-yl acrylate; 1,3-bis(2,4,6-tribromophenylthio)propan-2-yl acrylate; 1,3-di(10H-phenothiazin-10-yl)propan-2-yl acrylate; 1,3-bis(2-(phenylthio)ethylthio)propan-2-yl acrylate; 1-phenoxy-3-(phenylthio)propan-2-yl acrylate; 1-(4-chlorophenoxy)-3-(phenylthio)propan-2-yl acrylate; 1-(4-bromophenoxy)-3-(4-bromophenylthio)propan-2-yl acrylate; 1-(2,4,6-tribromophenoxy)-3-(2,4,6-tribromophenylthio)propan-2-yl acrylate; or 1-(2,4-dibromophenoxy)-3-(2,4-dibromophenylthio)propan-2-yl acrylate.

Methods to prepare the high refractive index sulfur-containing monomers can be found in U.S. patent application Publication 2005-0049376 to Chisholm et al. and U.S. Pat. No. 7,045,558 to Chisholm et al., each of which is incorporated herein in its entirety.

The high refractive index sulfur-containing monomer may be present in the polymerizable composition in an amount of about 1 to about 99 weight percent, specifically about 10 to about 90 weight percent, more specifically about 20 to about 80 weight percent, yet more specifically about 30 to about 70 weight percent, and still yet more specifically about 40 to about 50 weight percent based on the total weight of the polymerizable composition.

The polymerizable composition may optionally further comprise additional polymerizable monomers, oligomers, and the like. Such additional components may be selected based on their refractive indices, viscosities, or other physical and chemical properties.

Additional monomers, including high refractive index monomers, that can be used in combination with the high-refractive index sulfur-containing monomer include heterocyclic (meth)acrylates comprising higher atomic weight atoms, for example selenium, phosphorous, chlorine, bromine, or iodine that contribute to the overall refractive index of the composition. Specific classes of heterocycles include, for example, benzoxazoles, cyclic selenides, pyridines, selenoxanthenes, benzoselofurans, selenopyrans, selenophenes, selenazoles, and the like.

Other suitable high refractive index monomers suitable for use in combination with the high refractive index sulfur-containing monomers include those having the general structure (III)

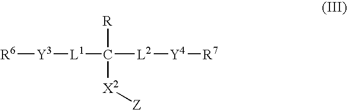

wherein Z is an ethylenically unsaturated group; X is O or NH; L¹ and L² are each independently, C₁-C₃ alkylene, —(C₁-C₃ alkylene)-S—(C₁-C₃ alkylene)-, or —(C₁-C₃ alkylene)-O—(C₁-C₃ alkylene)-; R is hydrogen or C₁-C₆ alkyl; R⁶ and R⁷ are each independently aryl, including phenyl or naphthyl, aryl(C₁-C₆ alkylene)-, heteroaryl, or heteroaryl(C₁-C₆ alkylene)-, each of which group is substituted with 0 to 5 substituents independently chosen from halogen, C₁-C₄alkyl, C₁-C₄alkoxy, (C₁-C₄alkyl)S—, C₁-C₄haloalkyl, and C₁-C₄haloalkoxy; and Y³ and Y⁴ are each independently O, NH, or N.

When Y³ or Y⁴ is N, then each corresponding combination R⁶—Y³ or R⁷—Y⁴ is independently an N-containing heteroaryl, wherein the nitrogen of the heteroaryl is covalently bonded to the L¹ or L² group respectively.

Specific examples of high refractive index monomers according to general structure (III) include 1,3-bis(2-bromophenoxy)propan-2-yl acrylate; 1,3-bis(4-bromophenoxy)propan-2-yl acrylate; 1,3-bis(3-bromophenoxy)propan-2-yl acrylate; 1,3-bis(phenoxy)propan-2-yl acrylate; and 1,3-bis(2,4,6-tribromophenoxy)-2-propyl acrylate.

The high refractive index monomers according to structure (III) exhibit a range of viscosities depending upon the substitution. Those monomers having a range of viscosity from about 1 centaPoise (cP) to about 1000 cP are suitable as monomer diluents due to their low viscosity. Such monomers may be used in polymerizable compositions containing higher viscosity components to provide polymerizable compositions having a desired viscosity for ease of processing. The high refractive index monomers useful as diluents exhibit a viscosity of about 1 centaPoise (cP) to about 1000 cP, more specifically about 5 cP to about 700 cP, and yet more specifically about 10 cP to about 400 cP measured using a Brookfield LVDV-II Cone/Plate Viscometer at 25° C.

The high refractive index monomers generally exhibit a refractive index of greater than or equal to about 1.50, more specifically greater than or equal to about 1.55, and yet more specifically greater than or equal to about 1.60.

Other suitable additional monomers include alkyl, cycloalkyl, and aryl mono-substituted (meth)acrylate compounds. An exemplary additional monomer has the general structure (IV)

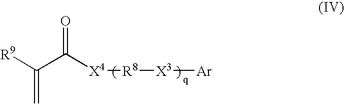

wherein R⁹ is hydrogen or methyl; X⁴ is O, S or NH; each occurrence of X³ is O, S, NH, or a chemical bond linking adjacent groups; wherein each occurrence of R⁸ is substituted or unsubstituted C₁-C₆ alkyl or alkenyl; q is 0, 1, 2, or 3; Ar is substituted or unsubstituted C₆-C₁₂ aryl including phenyl; wherein the substitution on the R⁸ and Ar independently include aryl, halo, C₁-C₆ alkyl, C₁-C₄ haloalkyl, C₁-C₄ haloalkoxy, (C₁-C₄alkyl)S—, hydroxy, C₁-C₆ ketone, C₁-C₆ ester, N,N—(C₁-C₃) alkyl substituted amide, or a combination thereof. The Ar group, when substituted, may be mono-, di-, tri-, tetra- or penta-substituted.

Exemplary additional monomers include 2-phenoxyethyl (meth)acrylate; 2-phenylthioethyl(meth)acrylate; phenyl(meth)acrylate; 2-, 3,-, and 4-bromophenyl(meth)acrylate; 2,4,6-tribromophenyl(meth)acrylate; tetrabromophenyl(meth)acrylate; pentabromophenyl(meth)acrylate; benzyl(meth)acrylate; 2-, 3,-, and 4-bromobenzyl(meth)acrylate; 2,4,6-tribromobenzyl(meth)acrylate; tetrabromobenzyl(meth)acrylate; pentabromobenzyl(meth)acrylate; methyl(meth)acrylate; butyl(meth)acrylate; 2-hydroxyethyl(meth)acrylate; cyclohexyl(meth)acrylate; tetrahydrofurfuryl(meth)acrylate; dicyclopentanyl(meth)acrylate; dicyclopentenyl(meth)acrylate; 3-phenyl-2-hydroxypropyl(meth)acrylate; ortho-biphenyl(meth)acrylate; 3-(2,4-dibromophenyl)-2-hydroxypropyl(meth)acrylate; and the like.

The additional monomer, inclusive of high refractive index monomer, may be present in the polymerizable composition in an amount of 0 to about 30, specifically about 1 to about 20 and more specifically about 3 to about 15 weight percent based on the total weight of the polymerizable composition.

The polymerizable composition may further optionally comprise a polymerizable oligomer. In one embodiment, the polymerizable oligomer has the general structure (V)

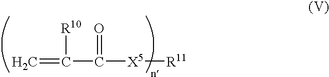

wherein R¹⁰ is hydrogen or methyl; X⁵ is O or S; R¹¹ is substituted or unsubstituted C₁-C₃₀₀ alkyl, aryl, alkaryl, arylalkyl, or heteroaryl; and n′ is 2, 3, or 4. The substitution on R¹¹ includes, but is not limited to, halo, C₁-C₆ alkyl, C₁-C₃ haloalkyl, C₁-C₄ haloalkoxy, (C₁-C₄alkyl)S—, hydroxy, C₁-C₆ ketone, C₁-C₆ ester, N,N—(C₁-C₃) alkyl substituted amide, or a combination thereof. Exemplary R¹¹ groups include such groups as alkylene and hydroxy alkylene disubstituted bisphenol-A or bisphenol-F ethers, especially the brominated forms of bisphenol-A and -F. Suitable R¹¹ groups include those having the general structure (VI)

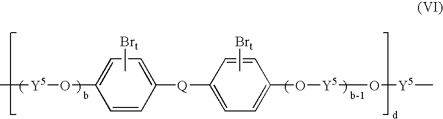

wherein Q is —C(CH₃)₂—, —CH₂—, —C(O)—, —S(O)—, —S—, —O—, or —S(O)₂—; Y⁵ is C₁-C₆ branched or straight chain alkylene, hydroxy substituted C₁-C₆ alkylene; b is independently at each occurrence 1 to 10; t is independently at each occurrence 0, 1, 2, 3, or 4; and d is about 1 to about 3.

The polymerizable oligomer may include compounds produced by the reaction of (meth)acrylic acid or hydroxy substituted (meth)acrylate with a di-epoxide, such as bisphenol-A diglycidyl ether; bisphenol-F diglycidyl ether; tetrabromo bisphenol-A diglycidyl ether; tetrabromo bisphenol-F diglycidyl ether; 1,3-bis-{4-[1-methyl-1-(4-oxiranylmethoxy-phenyl)-ethyl]-phenoxy}-propan-2-ol; 1,3-bis-{2,6-dibromo-4-[1-(3,5-dibromo-4-oxiranylmethoxy-phenyl)-1-methyl-ethyl]-phenoxy}-propan-2-ol; 1-(3-(2-(4-((oxiran-2-yl)methoxy)phenyl)propan-2-yl)phenoxy)-3-(4-(2-(4-((oxiran-2-yl)methoxy)phenyl)propan-2-yl)phenoxy)propan-2-ol; and the like; and a combination thereof. Examples of such compounds include acrylic acid 3-(4-{1-[4-(3-acryloyloxy-2-hydroxy-propoxy)-3,5,-dibromo-phenyl]-1-methyl-ethyl}-2,6-dibromo-phenoxy)-2-hydroxy-propyl ester; acrylic acid 3-[4-(1-{4-[3-(4-{1-[4-(3-acryloyloxy-2-hydroxy-propoxy)-3,5-dibromo-phenyl]-1-methyl-ethyl}-2,6-dibromo-phenoxy)-2-hydroxy-propoxy]-3,5-dibromo-phenyl}-1-methyl-ethyl)-2,6-dibromo-phenoxy]-2-hydroxy-propyl ester; and the like, and a combination thereof.

Other exemplary polymerizable oligomers include 2,2-bis(4-(2-(meth)acryloxyethoxy)phenyl)propane; 2,2-bis((4-(meth)acryloxy)phenyl)propane; 2,2-bis(4-(meth)acryloyloxydiethoxyphenyl)propane; 2,2-bis(4-(meth)acryloyloxytriethoxyphenyl)propane; 2,2-bis(4-(meth)acryloyloxytetraethoxyphenyl)propane; 2,2-bis(4-(meth)acryloyloxypentaethoxyphenyl)propane; 2,2-bis(4-(meth)acryloyloxyethoxy-3,5-dibromophenyl)propane; 2,2-bis(4-(meth)acryloyloxydiethoxy-3,5-dibromophenyl)propane; bis(4-(meth)acryloyloxypentaethoxy-3,5-dibromophenyl)propane; bis(4-(meth)acryloyloxyphenyl)methane; bis(4-(meth)acryloyloxyethoxyphenyl)methane; bis(4-(meth)acryloyloxydiethoxyphenyl)methane; bis(4-(meth)acryloyloxytriethoxyphenyl)methane; bis(4-(meth)acryloyloxytetraethoxyphenyl)methane; bis(4-(meth)acryloyloxypentaethoxyphenyl)methane; bis(4-(meth)acryloyloxydiethoxyphenyl)sulfone; bis(4-(meth)acryloyloxypentaethoxyphenyl)sulfone; bis(4-(meth)acryloyloxydiethoxyphenyl)sulfide; bis(4-(meth)acryloyloxypentaethoxyphenyl)sulfide; bis(4-(meth)acryloyloxydiethoxy-3,5-dimethylphenyl)sulfide; bis(4-(meth)acryloyloxypentaethoxy-3,5-dimethylphenyl)sulfide; and the like.

A suitable polymerizable oligomer based on the reaction product of tetrabrominated bisphenol-A di-epoxide and acrylic acid is RDX 51027 available from UCB Chemicals. Other commercially available polymerizable oligomers include EB600, EB3600, EB3605, EB3700, EB3701, EB3702, EB3703, and EB3720, all available from UCB Chemicals, or CN104 and CN120 available from Sartomer.

In one embodiment the polymerizable oligomer comprises a urethane (meth)acrylate. Such materials can be prepared, for example, by the reaction of two molar equivalents of an alkylene diisocyanate of the formula OCN—R₁₂—NCO with one molar equivalent of a diol of the formula HO—R¹³—OH, wherein each of R¹² and R¹³ is independently a C₂₋₁₀₀ alkylene group, to form a urethane diol diisocyanate, followed by reaction with a hydroxyalkyl(meth)acrylate. One example is the reaction product an aromatic diisocyanate (e.g. TDI) with a polyester diol followed by reaction with hydroxyalkyl acrylate. Also contemplated are the thiol versions of the above urethane (meth)acrylate prepared from dithiols of the formula HS—R¹³—SH. Such materials containing sulfur atoms provide an increase in refractive index of the polymerizable oligomer, and, in turn, increases the refractive index of the resulting polymerizable compositions.

Other polymerizable oligomers include, for example, polyol poly(meth)acrylates, which are typically prepared from aliphatic diols, triols and/or tetraols containing 2-100 carbon atoms. Examples of suitable poly(meth)acrylates are ethylene glycol diacrylate, 1,6-hexanediol diacrylate, neopentylglycol di(meth)acrylate, ethyleneglycol di(meth)acrylate, polyethyleneglycol (n=2-15) di(meth)acrylate, polypropyleneglycol (n=2-15) di(meth)acrylate, polybutyleneglycol (n=2-15) di(meth)acrylate, 2,2-bis(4-(meth)acryloxyethoxyphenyl)propane, 2,2-bis(4-(meth)acryloxydiethoxyphenyl)propane, 2,2-bis(4-(meth)acryloxyethoxy-3,5-dibromophenyl)propane, pentaerythritol tri(meth)acrylate, pentaerythritol tetra(meth)acrylate, dipentaerythritol penta(meth)acrylate, dipentaerythritol hexa(meth)acrylate, 2-ethyl-2-hydroxymethyl-1,3-propanediol tri(meth)acrylate (trimethylolpropane tri(meth)acrylate), di(trimethylolpropane) tetra(meth)acrylate, and the (meth)acrylates of alkoxylated (usually ethoxylated) derivatives of said polyols. Also included are N,N′-alkylenebisacrylamides, specifically those containing a C₁₋₄ alkylene group.

The polymerizable oligomer may be present in the polymerizable composition in an amount of 0 to about 75 weight percent, specifically about 5 to about 60 weight percent, more specifically about 10 to about 50 weight percent, yet more specifically about 15 to about 55 weight percent, and still yet more specifically about 20 to about 50 weight percent based on the total weight of the polymerizable composition.

The polymerizable composition may further comprise a polymerization initiator to promote polymerization of the ethylenically unsaturated components. Suitable polymerization initiators include photoinitiators that promote polymerization of the components upon exposure to ultraviolet radiation. Particularly suitable photoinitiators include phosphine oxide photoinitiators. Examples of such photoinitiators include the IRGACURE® and DAROCUR™ series of phosphine oxide photoinitiators available from Ciba Specialty Chemicals; the LUCIRIN® series from BASF Corp.; and the ESACURE® series of photoinitiators. Other useful photoinitiators include ketone-based photoinitiators, such as hydroxy- and alkoxyalkyl phenyl ketones, and thioalkylphenyl morpholinoalkyl ketones. Also suitable are benzoin ether photoinitiators.

The polymerization initiator may include peroxy-based initiators that can promote polymerization under thermal activation. Examples of useful peroxy initiators include, for example, benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, alpha,alpha′-bis(t-butylperoxy-m-isopropyl)benzene, 2,5-dimethyl-2,5-di(t-butylperoxy)hexane, dicumylperoxide, di(t-butylperoxy isophthalate, t-butylperoxybenzoate, 2,2-bis(t-butylperoxy)butane, 2,2-bis(t-butylperoxy)octane, 2,5-dimethyl-2,5-di(benzoylperoxy)hexane, di(trimethylsilyl)peroxide, trimethylsilylphenyltriphenylsilyl peroxide, and the like, and a combination thereof.

The polymerization initiator may be used in an amount of about 0.0001 to about 10 weight percent based on the total weight of the polymerizable composition, specifically about 0.1 weight percent to about 5 weight percent, more specifically about 0.5 weight percent to about 3 weight percent.

The polymerizable composition may, optionally, further comprise an additive selected from flame retardants, antioxidants, thermal stabilizers, ultraviolet stabilizers, dyes, colorants, anti-static agents, surfactant, and the like, and a combination thereof, so long as they do not deleteriously affect the polymerization of the composition.

The polymerizable composition may be prepared by simply blending the components thereof, with efficient mixing to produce a homogeneous mixture. In one embodiment, the functionalized metal oxide nanoparticles may be provided as a sol or dispersion in an aqueous or organic solvent. The sol or dispersion is blended with a high refractive index sulfur-containing monomer, optional other monomers or oligomers, and optional polymerization initiator to form a blend, followed by removal of the solvent. The removal of solvent may occur before or after casting into a mold or other molding processes. Removal of the solvent may be accomplished under reduced pressure or heat, such as by distillation or evaporation. For example, in cast films, the functionalized metal oxide nanoparticle sol and high refractive index sulfur-containing monomer mixture may be cast as a film and the solvent allowed to flash off prior to curing.

In one aspect, the polymerizable composition is free of solvent, yet are still easily processed into films or sheets.

When forming articles from the polymerizable composition, it is often useful to remove air bubbles from the composition by application of vacuum or the like, with gentle heating if the mixture is viscous. The composition can then be charged to a mold that may bear a microstructure to be replicated and polymerized by exposure to ultraviolet radiation or heat to produce a cured article.

An alternative method includes applying the polymerizable composition to a surface of a base film substrate, passing the base film substrate having the polymerizable composition coating through a compression nip defined by a nip roll and a casting drum having a negative pattern master of the microstructures. The compression nip applies a sufficient pressure to the polymerizable composition and the base film substrate to control the thickness of the composition coating and to press the composition into full dual contact with both the base film substrate and the casting drum to exclude any air between the composition and the drum. The polymerizable composition is cured by directing radiation energy through the base film substrate from the surface opposite the surface having the composition coating while the composition is in full contact with the drum to cause the microstructured pattern to be replicated in the cured composition layer. This process is particularly suited for continuous preparation of a cured composition in combination with a substrate.

Heat or radiation may be used to cure the polymerizable composition. Radiation curing includes microwave, ultraviolet light, visible light, and/or electron beam.

The polymerizable compositions can be cured by UV radiation. The wavelength of the UV radiation may be from about 1800 angstroms to about 4000 angstroms. Suitable wavelengths of UV radiation include, for example, UVA, UVB, UVC, UVV, and the like; the wavelengths of the foregoing are well known in the art. The lamp systems used to generate such radiation include ultraviolet lamps and discharge lamps, as for example, xenon, metallic halide, metallic are, low or high pressure mercury vapor discharge lamp, etc. Curing is meant both polymerization and cross-linking to form a non-tacky material.

When heat curing is used, the temperature selected may be about 80° to about 130° C., specifically about 90° C. to about 100° C. The heating period may be of about 30 seconds to about 24 hours, specifically about 1 minute to about 10 hours, and more specifically about 2 minutes to about 5 hours, and yet more specifically about 5 minutes to about 3 hours. Such curing may be staged to produce a partially cured and often tack-free composition, which then is fully cured by heating for longer periods or temperatures within the aforementioned ranges.

In one embodiment, the composition may be both heat cured and UV cured.

In another embodiment, the composition is subjected to a continuous process to prepare a cured film material in combination with a substrate.

Other embodiments include the reaction product obtained by curing any of the above polymerizable compositions.

The refractive index of the reaction product of the polymerizable composition may be greater than or equal to about 1.50, more specifically greater than or equal to about 1.53, and yet more specifically greater than or equal to about 1.55.

Still other embodiments include articles made from any of the cured compositions. Articles that may be fabricated from the compositions include, for example, optical articles, such as light management films (LMF) for use in backlit displays; projection displays; traffic signals; illuminated signs; optical lenses; Fresnel lenses; optical disks; diffuser films; holographic substrates; or as substrates in combination with conventional lenses, prisms or mirrors.

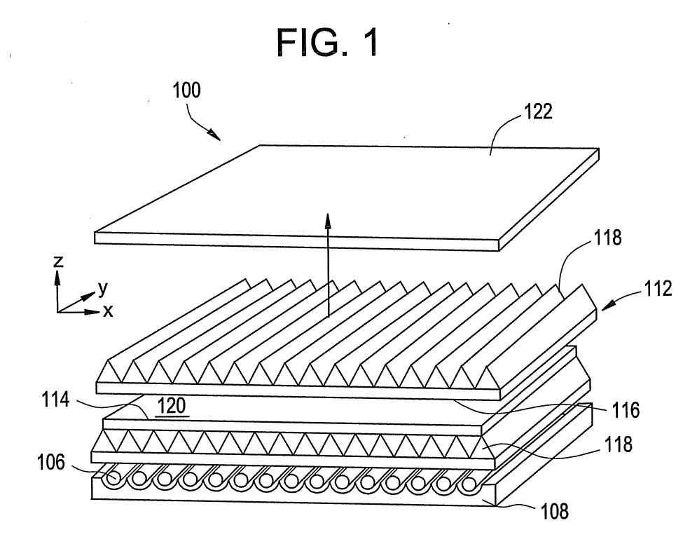

Exemplary light management films that can be prepared from the compositions include the films disclosed in U.S. patent application Publication No. 2006-0114569 to Capaldo et al., which is incorporated herein by reference. Referring now to FIG. 1, a perspective view of a backlit display device generally designated 100 is illustrated. The backlit display device 100 comprises an optical source 106 for generating light. A reflective film 108 in physical and/or optical communication the light source 106 reflects the light toward the liquid crystal display (LCD) 122. A multiwall sheet 120 that is in optical communication with the light source 106, e.g., generally disposed at a distance of up to about 15 millimeters (mm) from the light source. From a viewing side of multiwall sheet 120, the light passes from the multiwall sheet 120, optionally through diffuser sheet(s) (not shown), and into a light management sheet that functions to collimate light 112.

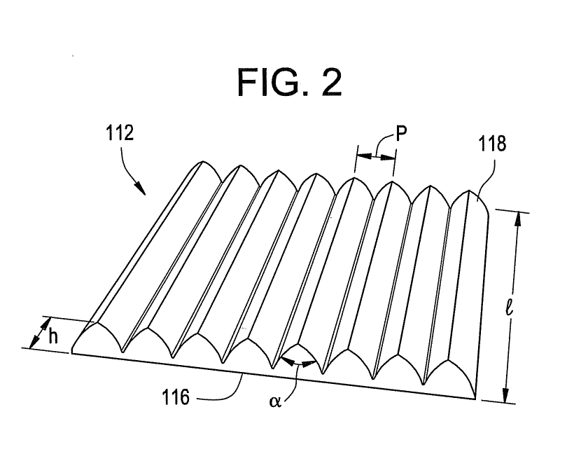

The light management sheet 112 comprises a planar surface 116 in physical or optical communication with the viewing side 114 of multiwall sheet 120, and a prismatic surface 118. Still further, it will be appreciated that the prismatic surfaces 118 can comprise a peak angle, α; a height, h; a pitch, p; and a length; l (see exemplary FIG. 2) such that the structure of the light management sheet 112 can be deterministic, periodic, random, and so forth. For example, films with prismatic surfaces with randomized or pseudo-randomized parameters are described for example in U.S. patent application Publication No. 2003-0214728 to Olcazk. Moreover, it is noted that for each prism the sidewalls (facets) can be straight-side, concave, convex, and so forth. The peak of the prism can be pointed, multifaceted, rounded, blunted, and so forth. More particularly, in some embodiments the prisms comprise straight-sided facets having a pointed peak (e.g., a peak comprising a radius of curvature of about 0.1% to about 30% of the pitch (p)), particularly about 1% to about 5%).

The multiwall sheet 120, which is receptive of the light, diffuses (e.g., scatters) the light. The light management sheet 112 receives the light and acts to direct the light in a direction that is substantially normal to the light management sheet 112 as indicated schematically by an arrow representing the light being directed in a z-direction shown in FIG. 1. The light proceeds from the light management sheet 112 to a liquid crystal display (LCD) 122. Optionally, reflective polarizing sheet(s) can also be employed between the multiwall sheet and the LCD. The reflective polarizing sheet(s) (e.g., a recycling polarizer sheet) reflects some polarized light (e.g., the polarized light that is not in the correct direction to be received by the LCD), while transmitting other polarized light.

Further, it is noted that in various embodiments a backlit display device can comprise a plurality of light management sheet(s) and a plurality of diffusing films in optical communication with each other. The multiwall sheet(s), light management sheet(s), and diffusing film(s) can be arranged in any configuration to obtain the desired results in the display device. Additionally, the light management sheet(s) can be arranged such that the prismatic surfaces are positioned at an angle with respect to one another, e.g., 90 degrees. Generally, the arrangement and type of light management sheets, multiwall sheet(s) and diffusing film(s) depends on the backlit display device in which they are employed.

The invention is further illustrated by the following non-limiting examples.

### EXAMPLES

### Examples 1-4

### Preparation of a Polymerizable Composition Comprising Functionalized Metal Oxide Nanoparticles and a High Refractive Index Sulfur-Containing Monomer

A titanium oxide sol, functionalized with methacryloxypropyl trimethoxysilane (MAPTMS), is prepared in accordance with Example 1 of U.S. patent application No. 2005-0063898 to Chisholm. The sol is combined with the high refractive index sulfur-containing acrylates provided in Table 1 to form polymerizable compositions (amounts in grams).

TABLE 1

| | Ex- | Ex- | Ex- | Ex- |
|---|---|---|---|---|
| Component | ample 1 | ample 2 | ample 3 | ample 4 |
| Titanium oxide sol functionalized | 500 | 500 | 500 | 500 |
| with MAPTMS | | | | |
| 2-(2-benzothiazolylthio)ethyl | 50 | — | — | — |
| acrylate | | | | |
| 1,3-bis(thiophenyl)propan-2-yl | — | 50 | — | — |
| acrylate | | | | |
| 1,3-bis(2- | — | — | 50 | — |
| mercaptobenzothiazoyl)propan-2- | | | | |
| yl acrylate | | | | |
| 2-(4-chlorophenoxy)-1- | — | — | — | 50 |
| [(phenylthio)methyl]ethyl acrylate | | | | |

The acrylate is slowly added to the functionalized titanium oxide sol using rapid stirring during the addition. The resulting mixture is then solvent stripped using a rotary evaporator operating at a temperature between 40-50° C. and full vacuum to result in a polymerizable composition exhibiting a high refractive index.

### Examples 5-8

### Preparation of a Polymerizable Composition Containing an Additional Polymerizable Oligomer

The polymerizable compositions of Examples 1-4 are further combined with, in a 1:1 weight ratio, a diacrylate tetrabromobisphenol A di-epoxide, available from UCB Chemicals under the tradename RDX51027. A small amount of polymerization initiator Darocur 4265, available from Ciba Specialty Chemicals, is also added to the final mixture. The resulting mixture can be cast as films and cured with an H bulb lamp to result in cured films exhibiting high refractive indices.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A polymerizable composition, comprising:
functionalized metal oxide nanoparticles; and
a high refractive index sulfur-containing monomer according to the general structures (I) or (II) 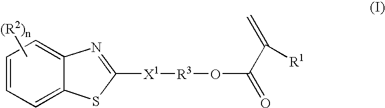
wherein R¹ is hydrogen or methyl;
R² is independently at each occurrence a C₁-C₂₀ alkyl, C₃-C₃₀ cycloalkyl, C₄-C₂₀ aryl, C₄-C₂₀ heteroaryl, (C₁-C₂₀alkyl)S—, C₁-C₂₀alkoxy, (C₁-C₂₀alkyl)₂N—, (C₁-C₂₀alkyl)(H)N—, halogen, nitro, or cyano group;
n is an integer from 0-4;
X¹ is a bond, a sulfur atom, selenium atom, SO group (sulfoxide), SO₂ (sulfonyl group), oxygen atom, amino group, carbonyl group, or carbonyloxy group; and
R³ is C₁-C₂₀ alkylene, C₃-C₃₀ cycloalkylene, or C₆-C₃₀ arylene; or 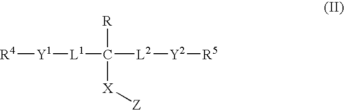
wherein Z is an ethylenically unsaturated group;
X is O, S, or NH; L¹ and L² are each independently C₁-C₃ alkylene, —(C₁-C₃ alkylene)-S—(C₁-C₃ alkylene)-, or —(C₁-C₃ alkylene)-O—(C₁-C₃ alkylene)-;
R is hydrogen or C₁-C₆ alkyl;
R⁴ and R⁵ are each independently aryl, including phenyl or naphthyl, aryl(C₁-C₆ alkylene)-, heteroaryl, or heteroaryl(C₁-C₆ alkylene)-, each of which group is substituted with 0 to 5 substituents independently chosen from halogen, C₁-C₄alkyl, C₁-C₄alkoxy, (C₁-C₄alkyl)S—, C₁-C₄haloalkyl, and C₁-C₄haloalkoxy; and
Y¹ and Y² are each independently O, S, NH, or N,
with the proviso that at least one of X, Y¹ or Y² is S.

2. The polymerizable composition of claim 1, wherein the high refractive index sulfur-containing monomer has the general structure (I) 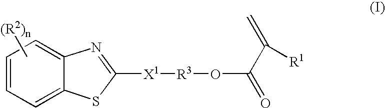
wherein R¹ is hydrogen or methyl;
R² is independently at each occurrence a C₁-C₂₀ alkyl, C₃-C₃₀ cycloalkyl, C₄-C₂₀ aryl, C₄-C₂₀ heteroaryl, (C₁-C₂₀alkyl)S—, C₁-C₂₀alkoxy, (C₁-C₂₀alkyl)₂N—, (C₁-C₂₀alkyl)(H)N—, halogen, nitro, or cyano group;
n is an integer from 0-4;
X¹ is a bond, a sulfur atom, selenium atom, SO group (sulfoxide), SO₂ (sulfonyl group), oxygen atom, amino group, carbonyl group, or carbonyloxy group; and
R³ is C₁-C₂₀ alkylene, C₃-C₃₀ cycloalkylene, or C₆-C₃₀ arylene.

3. The polymerizable composition of claim 1, wherein the high refractive index sulfur-containing monomer is 2-(2-benzothiazolylthio)ethyl acrylate or 2-(2-benzothiazolylthio)ethyl methacrylate.

4. The polymerizable composition of claim 1, wherein the functionalized metal oxide nanoparticles comprise silicon, titanium, zirconium, cerium, or tin oxide.

5. The polymerizable composition of claim 1, wherein the functionalized metal oxide nanoparticles have been functionalized with an organosilane.

6. The polymerizable composition of claim 5, wherein organosilane comprises epoxy or ethylenically unsaturated reactive groups.

7. The polymerizable composition of claim 5, wherein organosilane is free of epoxy or ethylenically unsaturated reactive groups.

8. The polymerizable composition of claim 1, wherein the functionalized metal oxide nanoparticles are prepared by a sol process comprising:
hydrolyzing metal alkoxide with an acidic alcohol solution, wherein the acidic alcohol solution comprises an alkyl alcohol, water, and an acid to form a first sol comprising metal oxide nanoparticles;
treating the first sol with an organosilane to form a second sol comprising treated metal oxide nanoparticles; and
treating the second sol with an organic base in an amount of about 0.1:1 to about 0.9:1 molar ratio of organic base to acid to form a third sol comprising treated metal oxide nanoparticles.

9. The polymerizable composition of claim 1, comprising
about 1 to about 80 weight percent of the functionalized metal oxide nanoparticles; and
about 20 to about 99 weight percent of the high refractive index sulfur-containing monomer, each based on the total weight of the polymerizable composition.

10. The polymerizable composition of claim 1, further comprising a polymerization initiator; an additional monomer; a polymerizable oligomer; or a combination thereof.

11. The polymerizable composition of claim 10, wherein the additional monomer has the general structure (III) or (IV) 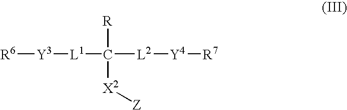
wherein Z is an ethylenically unsaturated group;
X² is O or NH;
L¹ and L² are each independently C₁-C₃ alkylene, —(C₁-C₃ alkylene)-S—(C₁-C₃ alkylene)-, or —(C₁-C₃ alkylene)-O—(C₁-C₃ alkylene)-;
R is hydrogen or C₁-C₆ alkyl;
R⁶ and R⁷ are each independently aryl, including phenyl or naphthyl, aryl(C₁-C₆ alkylene)-, heteroaryl, or heteroaryl(C₁-C₆ alkylene)-, each of which group is substituted with 0 to 5 substituents independently chosen from halogen, C₁-C₄alkyl, C₁-C₄alkoxy, (C₁-C₄alkyl)S—, C₁-C₄haloalkyl, and C₁-C₄haloalkoxy; and
Y³ and Y⁴ are each independently O, NH, or N;
or 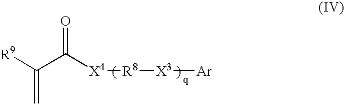
wherein R⁹ is hydrogen or methyl;
X⁴ is O, S or NH;
each occurrence of X³ is O, S, NH, or a chemical bond linking adjacent groups;
wherein each occurrence of R⁸ is substituted or unsubstituted C₁-C₆ alkyl or alkenyl;
q is 0, 1, 2, or 3;
Ar is substituted or unsubstituted C₆-C₁₂ aryl including phenyl; wherein the substitution on the R⁸ and Ar independently include aryl, halo, C₁-C₆ alkyl, C₁-C₄ haloalkyl, C₁-C₄ haloalkoxy, (C₁-C₄alkyl)S—, hydroxy, C₁-C₆ ketone, C₁-C₆ ester, N,N—(C₁-C₃) alkyl substituted amide, or a combination thereof.

12. The polymerizable composition of claim 10, wherein the additional monomer is present at about 1 to about 20 weight percent based on the total weight of the polymerizable composition.

13. The polymerizable composition of claim 10, wherein the polymerizable oligomer has the general structure (V) 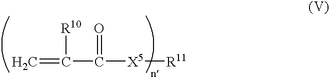
wherein R¹⁰ is hydrogen or methyl;
X⁵ is O or S;
n′ is 2, 3, or 4; and
R¹¹ has the general structure (VI) 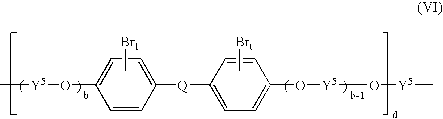
wherein Q is —C(CH₃)₂—, —CH₂—, —C(O)—, —S(O)—, —S—, —O—, or —S(O)₂—;
Y⁵ is C₁-C₆ branched or straight chain alkylene, hydroxy substituted C₁-C₆ alkylene;
b is independently at each occurrence 1 to 10;
t is independently at each occurrence 0, 1, 2, 3, or 4; and
d is about 1 to about 3.

14. The polymerizable composition of claim 10, wherein the polymerizable oligomer is present at about 5 to about 75 weight percent based on the total weight of the composition.

15. The polymerizable composition of claim 10, wherein the polymerization initiator is a photoinitiator.

16. The polymerizable composition of claim 10, wherein the polymerization initiator is present at about 0.0001 to about 10 weight percent based on the total weight of the composition.

17. A method of making a cured film, comprising:
blending functionalized metal oxide nanoparticles, a high refractive index sulfur-containing monomer, and optionally a polymerization initiator to form a polymerizable composition;
casting the polymerizable composition to form a film;
exposing the film to radiation energy or heat sufficient to polymerize the composition to form a cured film;
wherein the high refractive index sulfur-containing monomer has the general structure (I) or (II) 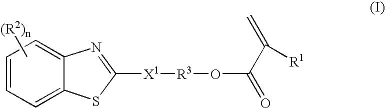
wherein R¹ is hydrogen or methyl;
R² is independently at each occurrence a C₁-C₂₀ alkyl, C₃-C₃₀ cycloalkyl, C₄-C₂₀ aryl, C₄-C₂₀ heteroaryl, (C₁-C₂₀alkyl)S—, C₁-C₂₀alkoxy, (C₁-C₂₀alkyl)₂N—, (C₁-C₂₀alkyl)(H)N—, halogen, nitro, or cyano group;
n is an integer from 0-4;
X¹ is a bond, a sulfur atom, selenium atom, SO group (sulfoxide), SO₂ (sulfonyl group), oxygen atom, amino group, carbonyl group, or carbonyloxy group; and
R³ is C₁-C₂₀ alkylene, C₃-C₃₀ cycloalkylene, or C₆-C₃₀ arylene;
or 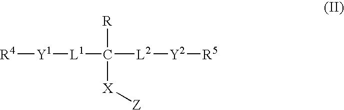
wherein Z is an ethylenically unsaturated group;
X is O, S, or NH; L¹ and L² are each independently C₁-C₃ alkylene, —(C₁-C₃ alkylene)-S—(C₁-C₃ alkylene)-, or —(C₁-C₃ alkylene)-O—(C₁-C₃ alkylene)-;
R is hydrogen or C₁-C₆ alkyl;
R⁴ and R⁵ are each independently aryl, including phenyl or naphthyl, aryl(C₁-C₆ alkylene)-, heteroaryl, or heteroaryl(C₁-C₆ alkylene)-, each of which group is substituted with 0 to 5 substituents independently chosen from halogen, C₁-C₄alkyl, C₁-C₄alkoxy, (C₁-C₄alkyl)S—, C₁-C₄haloalkyl, and C₁-C₄haloalkoxy; and
Y¹ and Y² are each independently O, S, NH, or N,
with the proviso that at least one of X, Y¹ or Y² is S.

18. The method of claim 17, wherein the functionalized metal oxide nanoparticles are provided as a sol or dispersion comprising a solvent, wherein the solvent is removed prior to exposing.

19. An article comprising the reaction product of the composition of claim 1.

20. The article of claim 19, wherein the article is a component of a backlit device.
